(19) United States
(12) Patent Application Publication
(10) Pub. No.: US 2023/0005165 A1
(43) Pub. Date: Jan. 5, 2023

(54) CROSS-TASK DISTILLATION TO IMPROVE DEPTH ESTIMATION

(71) Applicant: QUALCOMM Incorporated, San Diego, CA (US)

(72) Inventors: Hong CAI, San Diego, CA (US); Janarbek MATAI, San Diego, CA (US); Shubhankar Mangesh BORSE, San Diego, CA (US); Yizhe ZHANG, San Diego, CA (US); Amin ANSARI, Federal Way, WA (US); Fatih Murat PORIKLI, San Diego, CA (US)

(21) Appl. No.: 17/808,520

(22) Filed: Jun. 23, 2022

Related U.S. Application Data
(60) Provisional application No. 63/214,727, filed on Jun. 24, 2021.

(51) Int. Cl. G06T 7/50; G06N 3/08; G06N 3/04

(52) U.S. Cl. CPC G06T 7/50; G06N 3/08; G06N 3/0454; G06T 2207/20084; G06T 2207/20081

(57) ABSTRACT

Certain aspects of the present disclosure provide techniques for cross-task distillation. A depth map is generated by processing an input image using a first machine learning model, and a segmentation map is generated by processing the depth map using a second machine learning model. A segmentation loss is computed based on the segmentation map and a ground-truth segmentation map, and the first machine learning model is refined based on the segmentation loss.

### CROSS-REFERENCE TO RELATED APPLICATIONS

This application claims the benefit of and priority to U.S. Provisional Patent Application No. 63/214,727, filed on Jun. 24, 2021, the entire contents of which are incorporated herein by reference.

### INTRODUCTION

Aspects of the present disclosure relate to machine learning techniques.

In recent times, machine learning techniques, including deep learning, have increasingly been used to provide considerable accuracy in computer vision tasks. One such task is monocular depth estimation, where the depth of each element in an input image is inferred or predicted using a single image from a single vantage point (e.g., as compared with systems that rely on two or more images, with binocular disparity between them, to provide stereopsis and thereby determine depth). Monocular depth estimation can play an important role in three-dimensional visual scene understanding, and is of significant importance for a variety of application domains such as self-driving vehicles, augmented reality (AR) and virtual reality (VR) devices, drones or other autonomous devices, Internet of Things (IoT) devices, and robotics. However, accurate depth estimation is computationally complex and difficult to achieve.

Accordingly, techniques are needed for machine learning with accurate and computationally-efficient depth estimation.

### BRIEF SUMMARY

Certain aspects provide a method, comprising: generating a depth map by processing an input image using a first machine learning model; generating a segmentation map by processing the depth map using a second machine learning model; computing a segmentation loss based on the segmentation map and a ground-truth segmentation map; and refining the first machine learning model based on the segmentation loss.

Certain aspects provide a method, comprising: receiving an input image; generating an output depth map by processing the input image using a first machine learning model; generating a segmentation map by processing the depth map using a second machine learning model; computing a segmentation loss based on the segmentation map; and refining the first machine learning model based on the segmentation loss.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1A depicts an example workflow for training a depth model and a depth-to-segmentation model.

FIG. 1B depicts an example workflow for inferencing using a trained depth model.

FIG. 2A depicts an example workflow for training a depth model using photometric loss and segmentation loss.

FIG. 2B depicts an example workflow for training a depth model using ground-truth depth maps and segmentation loss.

FIG. 3 depicts an example flow diagram illustrating a method for training machine learning models for depth estimation.

FIG. 4 depicts an example flow diagram illustrating a method for generating segmentation loss to refine depth models.

FIG. 5 depicts an example flow diagram illustrating a method for training and inferencing using a depth model trained with the aid of a depth-to-segmentation model.

FIG. 6 depicts an example flow diagram illustrating a method for training a machine learning model based on segmentation loss.

FIG. 7 depicts an example flow diagram illustrating a method for inferencing using a machine learning model trained using segmentation loss.

FIG. 8 depicts an example processing system configured to perform various aspects of the present disclosure.

Additional aspects of the present disclosure can be found in the attached appendix.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for cross-task distillation to improve monocular depth estimation in machine learning models, such as neural networks.

Training accurate depth models in a supervised manner may require high-quality (e.g., dense and correctly aligned) ground-truth depth maps, which are difficult and costly to obtain. Some self-supervision techniques have emerged for training monocular depth estimation models. Additionally, semantic segmentation information has recently been used to improve prediction accuracy.

In existing systems, pre-trained or co-trained semantic segmentation models can be used to assist the depth model during both training and inferencing. While such approaches can improve accuracy, they incur significant extra computational expense. For example, using pre-trained models incurs vastly increased expense during inference, as they require running a separate (and generally computationally-expensive) segmentation model. Similarly, co-training a segmentation model that shares layers with the depth model incurs vastly increased expense during the training process.

In some aspects, cross-task knowledge distillation may be used to impart knowledge from semantic segmentation models (e.g., neural networks trained to provide semantic segmentation) to the depth estimation models (e.g., neural networks trained to generate depth maps based on input images). That is, during training, the semantic knowledge from pre-trained segmentation models can be transferred to the depth models, enhancing their capabilities and accuracy.

Notably, using a segmentation network to aid training of a depth network differs from more conventional knowledge distillation tasks, where the teacher and student networks share the same visual task. In aspects of the present disclosure, the outputs of the depth network (e.g., depth maps) and the semantic segmentation network (e.g., segmentation maps) are not directly comparable. Therefore, in some aspects, an efficient depth-to-segmentation model is trained to bridge this task-gap.

Generally, a depth map indicates, for each pixel in an input image, the depth (e.g., the distance from the camera) of the corresponding object covered by the pixel. For example, the depth map may be visualized as a heat map, where each pixel is shaded based on the inferred depth from the camera. Other implementations are also possible.

Generally, a semantic segmentation map classifies each pixel of an input image into a class based on the object covered by the pixel. For example, in a self-driving task, a segmentation model may be used to label each pixel based on whether it depicts a telephone pole, stop sign, road, sidewalk, tree, pedestrian, vehicle, and the like. Though tasks related to self-driving (such as depth estimation of vehicles and signs) are used in some examples herein, aspects of the present disclosure are readily applicable to a wide variety of tasks.

In order to enable such knowledge distillation across two different visual tasks, in aspects of the present disclosure, a depth-to-segmentation model (e.g., a neural network) is used to translate the predicted depth map (generated by a depth model) to a semantic segmentation map, which can then be compared against segmentation maps generated by a teacher network (e.g., a pre-trained segmentation model). The resulting loss can then be used to refine both the depth model and the depth-to-segmentation model. In this way, this depth-to-segmentation model enables backpropagation from the semantic segmentation model to the depth network during training.

In some aspects, once the depth model is trained, the other models (e.g., the depth-to-segmentation model and the pre-trained segmentation model) can be discarded, allowing the depth model to efficiently generate depth maps based on input images. This provides significant improvement over existing approaches that rely on segmentation models during inferencing. This can result in fewer operations and processing requirements, as well as reduced power use, processing time, and memory use.

Additionally, conventional approaches can often predict inconsistent depth values on a variety of objects, which visually appear as missing parts on the depth map (e.g., regions with infinite or indeterminate depth). For example, small, thin, and/or reflective objects (such as bikers, pedestrians, lamp posts, car windows and surfaces, and the like) may result in significant death map inaccuracy using conventional approaches. However, as aspects of the present disclosure enable the model to better understand the semantics of the scene, the model is able to generate more accurate and more semantically-structured depth maps.

Further, by using pre-trained segmentation models to generate segmentation maps, aspects of the present disclosure reduce the computational expense of training, as compared to existing approaches using semantic networks that share one or more layers with the depth networks. That is, because such approaches require co-training of semantic networks and depth networks, the expense of training is significant. In contrast, aspects of the present disclosure use pre-trained segmentation models and only train a small, lightweight depth-to-segmentation model alongside the depth model.

In some aspects, the semantic classes provided by a pre-trained semantic segmentation model can be consolidated to ensure they are directly transferable to the depth task. That is, some of the object classes, which are useful for segmentation tasks, may be intractable or irrelevant for depth tasks. For example, though a semantic segmentation model may be configured to treat “road” and “sidewalk” as separate object classes, it is not necessary to treat them differently on a depth map, as both are generally ground surfaces. Indeed, treating such classes as distinct in the depth task can reduce model accuracy, as they exhibit highly similar depth variation patterns in the field of view.

As such, in some aspects, the object classes are regrouped based on their visual and geometric characteristics. For example, a user may specify groupings of the available semantic classes. This allows the depth network to distill the key depth-relevant semantic information without introducing unnecessary difficulties to the learning process.

In some aspects, this regrouping or consolidation can allow the model to accurately predict depths for thin structures better, as compared to conventional approaches. For example, the model may be able to generate a more accurate and clear depth estimation for objects such as lamp posts and telephone poles, as such thin objects may be grouped as a class in the semantics-to-depth distillation, which encourages the depth network to pay more attention to recognize such structures.

Accordingly, aspects described herein overcome conventional limitations with monocular depth estimation through efficient cross-task distillation from a segmentation task to the depth task.

Example Workflow for Training a Depth Model Based on a Depth-to-Segmentation Model

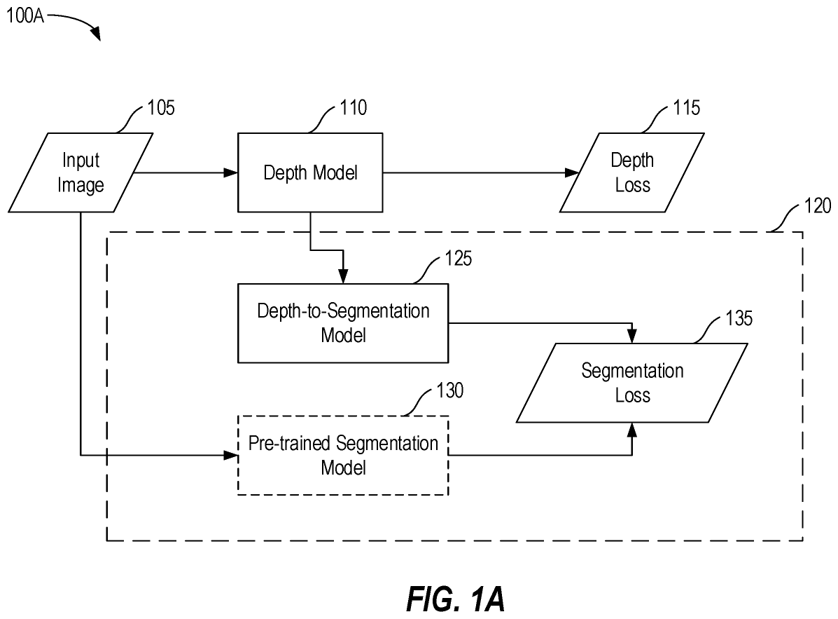

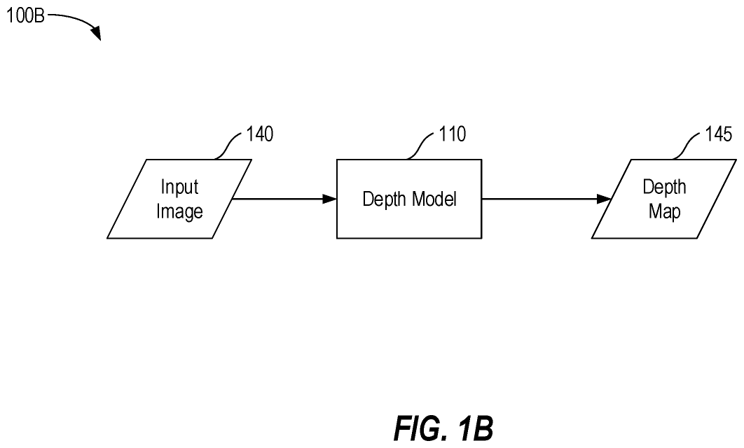

FIG. 1A depicts an example workflow 100A for training a depth model 110 and a depth-to-segmentation model 125.

In the workflow 100A, an input image 105 is processed using a depth model 110. The depth model 110 is generally a machine learning model configured to generate depth maps based on input images. As discussed above, the depth map may indicate, for each pixel in the input image 105, the depth (e.g., the distance from the camera) of the corresponding object covered by the pixel. In some aspects, the depth model is a neural network.

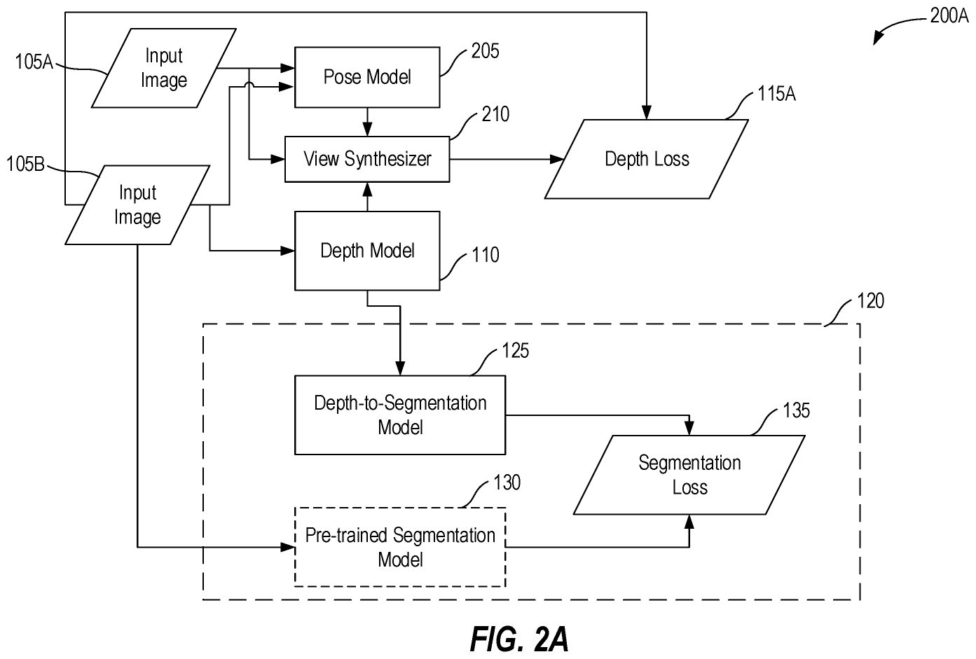

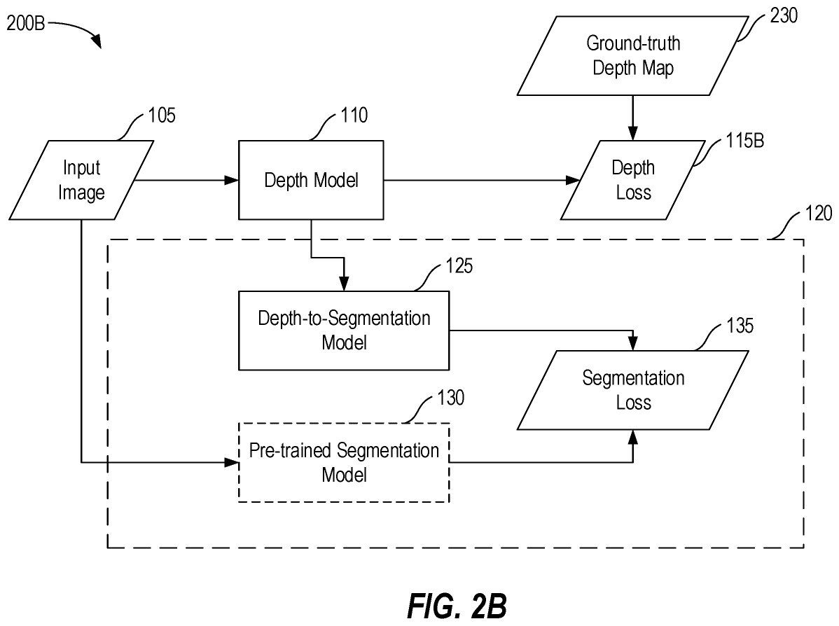

As illustrated, during the training process, the generated depth map can be used to compute a depth loss 115. In some aspects, the generated depth map is used to generate a synthesized version of the input image 105, which can be compared against the original input image 105 in order to generate the depth loss 115, as discussed in more detail below with reference to FIG. 2A. In some aspects, the generated depth map is compared against a ground-truth depth map in order to generate the depth loss 115, as discussed in more detail below with reference to FIG. 2B. Generally, the depth loss 115 can be used to iteratively refine the depth model 110 (e.g., using backpropagation).

In the illustrated workflow 100A, a cross-task distillation module 120 is used to transfer semantic knowledge from a pre-trained segmentation model 130 to the depth model 110. That is, if the depth model 110 is denoted as f_{D} and the pre-trained semantic segmentation model is denoted as f_{S}, then the cross-task distillation module 120 enables transfer of the knowledge of the teacher model, f_{S}, to the student model, f_{D}. However, unlike conventional knowledge distillation where teacher and student networks are used for the same visual task, f_{D} and f_{S} are used for two different tasks and their outputs are not directly comparable. In other words, given an input, the system cannot directly measure the difference between the outputs of f_{D} (a depth map) and f_{S} (a segmentation map) in order to generate a loss needed to train f_{D}.

In the illustrated aspect, therefore, a depth-to-segmentation model 125 (which may be denoted h_{D2S}) is used. In an aspect, the depth-to-segmentation model 125 is a neural network. In some aspects, the depth-to-segmentation model 125 is a small neural network (e.g., with just two conventional convolution layers and one pointwise convolution layer, or with a pointwise convolutional layer preceded by zero to four convolution layers), enabling it to be trained efficiently and with minimal computational expenditure.

For example, in one aspect, the depth-to-segmentation model 125 consists of two 3×3 convolutional layers (or any number of convolutional layers), each followed by a BatchNorm layer and a ReLu layer, as well as a pointwise convolutional layer at the end which outputs the segmentation map. In some aspects, using a deeper network for the depth-to-segmentation model 125 may result in improved accuracy of the depth model 110, but these improvements are not as significant as those achieved using a smaller depth-to-segmentation model 125. Further, a larger or deeper depth-to-segmentation model 125 may take an outsized role in the learning, thereby weakening the knowledge flow to the depth model 110.

In the workflow 100A, the depth-to-segmentation model 125 receives the depth map generated by the depth model 110 and translates it to a semantic segmentation map. Stated differently, the depth-to-segmentation model 125 generates a segmentation map based on an input depth map.

Additionally, as illustrated, the pre-trained segmentation model 130 is used to generate a segmentation map based on the original input image 105. Although a pre-trained segmentation model 130 is depicted, in some aspects, the cross-task distillation module 120 can use a ground-truth segmentation map for the input image 105 (e.g., provided by a user), rather than processing the input image 105 using the pre-trained segmentation model 130 to generate one. As used herein, the segmentation map used to generate the segmentation loss 135 (which may be provided by a user or generated by the pre-trained segmentation model 130) may be referred to as a “ground-truth” segmentation map to reflect that it is used as a ground-truth in computing the loss, even though it may in fact be a psuedo ground-truth map generated by the trained model. As used herein, the term “ground-truth segmentation map” can include both true or actual segmentation maps (e.g., provided by a user), as well as psuedo or generated ground-truth segmentation maps (e.g., generated by the pre-trained segmentation model 130).

Given the segmentation map generated by the depth-to-segmentation model 125 (based on the predicted depth map generated by the depth model 110) and the segmentation map generated by the pre-trained segmentation model 130 (based on the input image 105), the system is able to construct a segmentation loss 135. This segmentation loss 135 can then be used to distill the semantic knowledge from f_{S} to f_{D}. In one aspect, this new segmentation loss 135 is defined using Equation 1 below, where [symbol] _{D2S}(·) is the segmentation loss 135. Sₜ^{D} is the semantic segmentation map generated by the depth-to-segmentation model 125 based on the predicted depth map generated by the depth model 110 given input image 105. That is, Sₜ^{D}=h_{D2S}(f_{D} (Iₜ)), where Iₜ is the input image 105. Additionally, Sₜ is the semantic segmentation output generated by the pre-trained semantic segmentation model 130, [symbol] _{CE} denotes cross-entropy loss, and H and W are the height and width of the input image 105.

$${ℒ}_{D 2 S} ( {S}_{t}^{D} , {S}_{t} ) = {\sum }_{i = 1}^{H} {\sum }_{j = 1}^{W} \frac{{ℒ}_{CE} ( {S}_{t}^{D} ( i , j ) , {S}_{t} ( i , j ) )}{HW} \qquad ( Eq . 1 )$$

In the illustrated workflow 100A, the segmentation loss 135 can be used to allow the depth-to-segmentation model 125 to be jointly trained with the depth model 110. This makes it possible for the pre-trained segmentation model 130 to provide semantic supervision to the depth model 110, by backpropagating the segmentation loss 135 through the depth-to-segmentation model 125. That is, the segmentation loss 135 can be backpropagated through the depth-to-segmentation model 125 (e.g., generating gradients for each layer), and the resulting tensor or gradients output from the depth-to-segmentation model 125 can be backpropagated through the depth model 110.

Although the illustrated workflow 100A depicts a single input image 105 (suggesting stochastic gradient descent) for conceptual clarity, in aspects, the training workflow 100A may be used to provide training in batches of input images 105.

In some aspects, as discussed above, the semantic classes used by the pre-trained segmentation model 130 may be consolidated or grouped to enable improved training of the depth model 110. The semantic segmentation can often contain more fine-grained visual recognition information that is not present or realistic in depth maps. For example, road objects and sidewalk objects are typically treated as two different semantic classes, but depth maps generally do not contain such classification information as both road and sidewalk are on the ground plane and have similar depth variations. As a result, it is not necessary to differentiate them on the depth map. On the other hand, the depth map does contain the information for differentiating certain classes. For instance, a road participant (e.g., pedestrian, vehicle) can be easily separated from the background (e.g., road, building) given the different patterns of their depth values.

In some aspects, therefore, the semantic classes may be grouped or consolidated such that the semantic information is preserved while the unnecessary complexity is removed from the distillation. In one such aspect, the classes are consolidated to a first group for objects in the foreground (e.g., vehicles, pedestrians, signs, and the like) and a second group for objects in the background (e.g., buildings, the ground itself, and the like). In at least one aspect, the objects in the foreground are delineated into two subgroups based, for example, on their shapes. For example, the system may use a first group (or subgroup) for thin structures (e.g., traffic lights and signs, poles, and the like) and a second group (or subgroup) for broader shapes (such as people, vehicles, and the like).

Similarly, objects in the background may be split into a third group (or subgroup) and a fourth group (or subgroup), where the third group contains the background objects (e.g., buildings, vegetation, and the like) while the fourth group includes the ground (e.g., roads, sidewalks, and the like). This class consolidation, applied to the segmentation map generated by the pre-trained segmentation model 130, can improve the resulting accuracy of the depth model 110. In some aspects, this consolidation is performed based on a user-specified configuration (e.g., indicating which classes should be consolidated to a given group). In one aspect, consolidating the classes includes relabeling the segmentation map based on the groupings of classes. For example, if light poles and signs are consolidated to the same class, then they will be assigned the same value in the (new) segmentation map. The depth-to-segmentation model 125 is generally configured to output segmentation maps based on the consolidated classes.

As discussed above, the distillation approach only adds a small amount of computation to training, as the depth-to-segmentation model 125 can be small. Moreover, the segmentation maps from the teacher network (pre-trained segmentation model 130) need only be computed once for each training input image 105, and can thereafter be re-used as needed. This improves over existing systems that co-train a segmentation model alongside the depth model (which may require proccessing images with the segmentation model many times during training).

Example Workflow for Inferencing Using a Trained Depth Model

FIG. 1B depicts an example workflow 100B for inferencing using a trained depth model 110.

In the illustrated aspect, the depth model 110 has been trained using a cross-task distillation module, such as cross-task distillation module 120 discussed above with reference to FIG. 1A. That is, the depth model 110 may be trained based at least in part on a segmentation loss generated with the aid of a depth-to-segmentation model (such as depth-to-segmentation model 125, discussed above with reference to FIG. 1A). In this way, the depth model 110 learns segmentation knowledge that can enable significantly improved depth estimations.

Once the training is finished (e.g., determined based on termination criteria such as sufficient accuracy or otherwise determining that the model is sufficiently trained), the depth model 110 can run in a standalone manner, without requiring any extra computation of semantic information during inference. That is, input images 140 can be processed by the depth model 110 to generate accurate depth maps 145, without passing any data through the depth-to-segmentation model 125 or pre-trained segmentation model 130 of FIG. 1A. In some aspects, therefore, the cross-task distillation module 120 can be discarded after training. In some aspects, the depth-to-segmentation model 125 can be stored for use with future refinements or training.

In some aspects, during inferencing, however, only the depth model 110 is used. Because the depth model 110 is trained in a more semantic-aware manner using cross-task distillation, it exhibits superior accuracy as compared to existing systems.

Further, because the workflow 100B does not use a separate segmentation network or depth-to-segmentation model during inferencing, the computational resources needed (e.g., power consumption, latency, memory footprint, number of operations, and the like) are significantly reduced as compared to existing systems.

Example Workflow for Training a Depth Model Based on Photometric Loss

FIG. 2A depicts an example workflow 200A for training a depth model using photometric loss and segmentation loss. The workflow 200A generally provides more detail for the computation of the depth loss 115, discussed above with reference to FIG. 1A. Specifically, the workflow 200A uses a self-supervised approach to enable computation of a depth loss 115A and training of the depth model 110 without the need for ground-truth depth maps.

In the illustrated workflow 200B, input images 105A and 105B are neighboring (e.g., adjacent) or close (e.g., within a defined number of frames or timestamps) frames from a video. Both are provided to a pose model 205, which is configured to determine the relative camera motion between the input images 105A and 105B. Generally, the pose model 205 is a machine learning model (e.g., a neural network) that infers camera pose (e.g., locations and orientations in six-degrees of freedom) for input images.

For example, consider two neighboring or close video frames, Iₜ and Iₛ (e.g., input images 105A and 105B). Suppose that pixel Pₜ∈Iₜ and pixel Pₛ∈Iₛ are two different views of the same point of an object. In such a case, pₜ and pₛ are related geometrically as indicated in Equation 2 below, where h(p)=[h, w, 1] denotes the homogeneous coordinates of a pixel p with h and w being its vertical and horizontal positions on the image, d(p) is the depth at p, K is the camera intrinsic matrix, and T_{t→s} is the six-degree-of-freedom relative camera motion/nose from t to s

$$d ( {p}_{s} ) h ( {p}_{s} ) = [ K \vert 0 ] {T}_{t \to s} [ \begin{matrix}{K}^{- 1} d ( {p}_{t} ) h ( {p}_{t} ) \\ 1\end{matrix} ] \qquad ( Eq . 2 )$$

The determined pose, generated by the pose model 205, is provided to a view synthesizer 210. Additionally, the input image 105B can be provided to the depth model 110 to generate a predicted depth map for the image 105B. As depicted in the workflow 100B, this generated depth map is then provided to the view synthesizer 210.

Given the generated depth map of Iₜ (image 105B), which is output by the depth model 110 and may be denoted Dₜ, along with the relative camera pose from Iₜ (image 105B) to Iₛ (image 105A), which is output by the pose model 205, the view synthesizer 210 can synthesize Iₜ from Iₛ based on Equation 2, assuming that the points captured in Iₜ are also present in Iₛ. The synthesized version of the input image 105B (Iₜ) may be denoted as Îₜ.

As illustrated, by minimizing the difference between the synthesized image Îₜ and the actual image 105B (indicated by depth loss 115A), the system can train the pose model 205 and depth model 110. In some aspects, this depth loss 115A is referred to as a photometric loss (denoted [symbol] _{H}), and may be defined using Equation 3 below, where where ∥·∥₁ denotes the [symbol] ₁ norm and SSIM is the Structural Similarity Index Measure. Note that [symbol] _{PH} is computed in a per-pixel manner.

$${ℒ}_{PH} ( {I}_{t} , {\hat{I}}_{t} ) = α {‖ {I}_{t} - {\hat{I}}_{t} ‖}_{1} + ( 1 - α ) \frac{1 - SSIM ( {I}_{t} , {\hat{I}}_{t} )}{2} \qquad ( Eq . 3 )$$

In some aspects, the system may further include a smoothness regularization or loss to prevent drastic variations in the predicted depth map. Additionally, in some aspects, not all the 3D points in Iₜ can be found in Iₛ (e.g., due to occlusion and objects (entirely or partially) moving out of the frame). Some objects can also be moving (e.g., cars), which is not considered in the geometric model of Equation 2. In one such aspect, in order to correctly measure the photometric loss and train the networks, the system can mask out the pixel points that violate the geometric model.

In the illustrated workflow 200A, the depth model 110 is also refined based on the segmentation loss 135 (propagated through the depth-to-segmentation model 125), as discussed above. In one aspect, the total loss ( [symbol] _{Total}) for the depth model 110 can therefore defined using Equation 4 below, where the self-supervised depth loss is computed over Nₛ scales, [symbol] _{PH,k} is the photometric loss for the k^{th} scale, λ_{SM,k} and [symbol] _{SM,k} are the weight and loss for the smoothness regularization for the k^{th} scale, and λ_{D2S} is the weight of the cross-task distillation loss, L_{D2S}.

$${ℒ}_{Total} = {\sum }_{k = 1}^{{N}_{s}} {ℒ}_{PH , k} + {\sum }_{k = 1}^{{N}_{s}} {λ}_{SM , k} {ℒ}_{SM , k} + {λ}_{D 2 s} {ℒ}_{D 2 s} \qquad ( Eq . 4 )$$

Example Workflow for Training a Depth Model Based on Ground-Truth Maps

FIG. 2B depicts an example workflow 200B for training a depth model using ground-truth depth maps and segmentation loss. The workflow 200B generally provides more detail for the computation of the depth loss 115, discussed above with reference to FIG. 1A. Specifically, the workflow 200B uses ground-truth depth maps 230 to compute the depth loss 115B.

In the illustrated workflow 200B, a depth-to-segmentation model 125 can be used to compute a segmentation loss 135 which is used to refine the depth model 110, as discussed above with reference to FIG. 1A.

As further illustrated, for each input image 105, a corresponding ground-truth depth map 230 is used to compute the depth loss 115B. For example, the system may use cross-entropy to compute the depth loss 115B loss based on the ground-truth depth map 230 and predicted depth map generated by the depth model 110. This depth loss 115B can then be used, along with the segmentation loss 135, the refine the depth model 110.

Example Method for Training Machine Learning Models for Depth Estimation

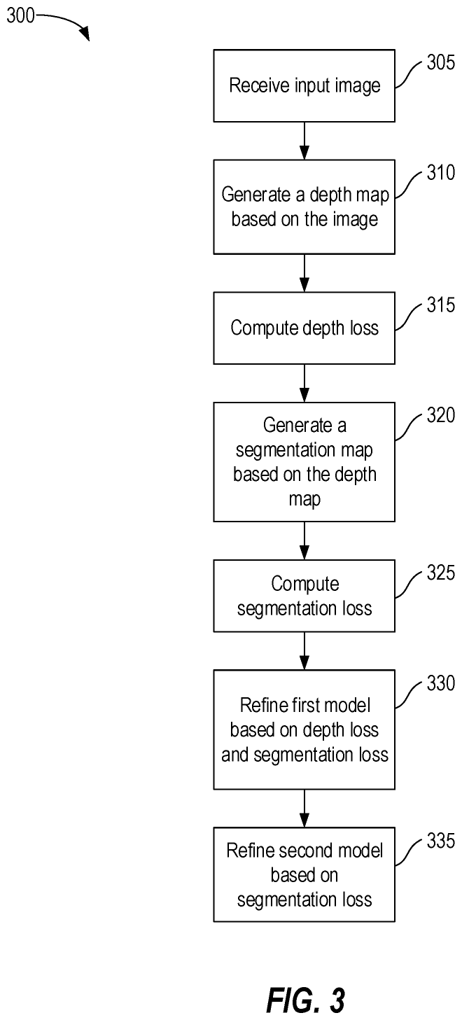

FIG. 3 depicts an example flow diagram illustrating a method 300 for training machine learning models for depth estimation.

The method 300 begins at block 305, where a training input image (e.g., input image 105 depicted in FIG. 1A) is received. In one aspect, the input image is generally a two-dimensional image depicting a three-dimensional scene with various objects are various depths. For example, the input image may be captured by a camera on a self-driving vehicle, and depict objects such as pedestrians, vehicles, signs, the road, and the like.

At block 310, the system generates a depth map based on the received image. For example, a depth neural network (such as depth model 110, discussed above with reference to FIG. 1A) may be used to translate the image to a depth map. As discussed above, the depth map generally indicates, for each pixel, the depth of the underlying object in the scene.

At block 315, the system computes a depth loss (e.g., depth loss 115 depicted in FIG. 1A). In one aspect, the system does so using a photometric loss computed based on the input image and one or more adjacent or nearby images from a video stream. One such aspect is discussed above with reference to FIG. 2A. In another aspect, the depth loss may be computed using a ground-truth depth map for the received image, as discussed above with reference to FIG. 2B.

At block 320, the system generates a segmentation map based on the depth map generated in block 310 using the depth model. For example, as discussed above, the system may use a depth-to-segmentation model 125 as part of a cross-task distillation module 120 (discussed with reference to FIG. 1A) to generate the segmentation map. In some aspects, the depth-to-segmentation model is a lightweight neural network (e.g., with a relatively few number of parameters, as compared to the depth model or pre-trained segmentation model), reducing computational expense.

At block 325, the system can compute a segmentation loss based on the segmentation map generated in block 320. For example, in one aspect, the system can compute a cross entropy loss between the generated segmentation map and a ground-truth segmentation map for the received image. In some aspects, the system uses a pre-trained segmentation model to generate a segmentation map (which may be referred to in some aspects as the ground-truth map) based on the image, and computes the loss based on the generated segmentation maps. In other aspects, the system uses a provided ground-truth segmentation map (e.g., provided by a user) to compute the loss. In at least one aspect, the semantic classes of the ground-truth segmentation map can be consolidated (e.g., to match the classes output by the depth-to-segmentation model), as discussed above, prior to generating the segmentation loss.

At block 330, the system refines a first model (e.g., the depth model used to generate the depth map in block 310) based on the depth loss and the segmentation loss. For example, the system may use backpropagation to refine the internal weights or other parameters of the depth model based on the depth loss. Further, the system may backpropagate the segmentation loss through the depth-to-segmentation model and subsequently through the depth model in order to refine the weights to gain semantic segmentation knowledge.

At block 335, the system similarly refines a second model (e.g., the depth-to-segmentation model used to generate the segmentation map in block 320) using the segmentation loss, as discussed above.

In this way, a depth model and lightweight depth-to-segmentation model are co-trained to allow segmentation knowledge to be passed to the depth model. This process can significantly improve the depth estimation accuracy of the depth model, as discussed above.

Though the method 300 depicts refining the models for each individual training sample (e.g., using stochastic gradient descent), in some aspects, the system may instead use batch training.

Note that FIG. 3 is just one example of a method, and other methods including fewer, additional, or alternative steps are possible consistent with this disclosure.

Example Method for Generating Segmentation Loss to Refine Depth Models

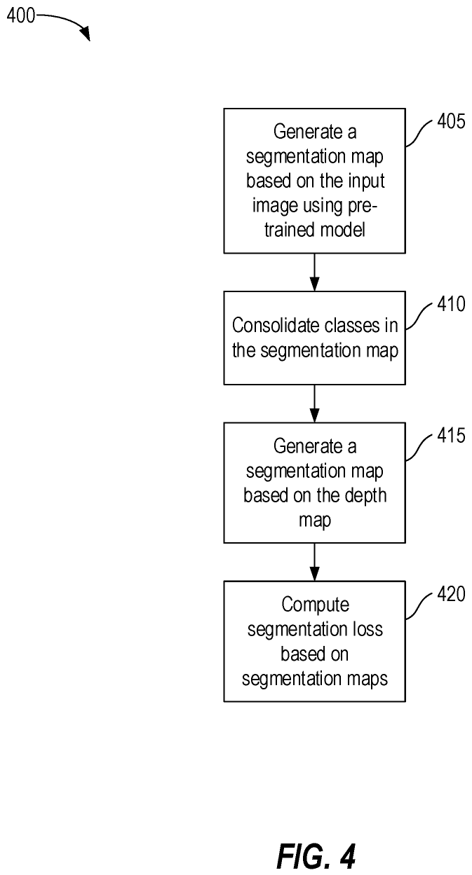

FIG. 4 depicts an example flow diagram illustrating a method 400 for generating segmentation loss to refine depth models. In some aspects, the method 400 provides additional detail for blocks 320 and 325 in FIG. 3.

The method 400 begins at block 405, where a segmentation map is generated by processing the received input image using a pre-trained segmentation model (e.g., the pre-trained segmentation model of FIG. 1A). This segmentation map can be used as a ground-truth to compute a segmentation loss.

At block 410, the system can consolidate the classes of the generated segmentation map. That is, as discussed above, the system may group two or more of the relevant classes based on a defined consolidation configuration (e.g., specified by a user). In one aspect, a user may specify a set of groups, where each group includes one or more classes output by the segmentation model. For example, the system may consolidate all ground classes (e.g., road, sidewalk, grass, and the like) to a first group, while ordinary obstacles (e.g., vehicles and pedestrians) are consolidated to a second group and thin obstacles (e.g., light poles) are consolidated to a third.

As discussed above, this class consolidation can improve prediction accuracy by training the models to focus on depth-relevant features of each semantic class. In some aspects, consolidating the classes in the segmentation map is performed to ensure that the classes in the segmentation map match the classes that the depth-to-segmentation model is configured to output.

At block 415, the system generates a segmentation map based on the depth map. For example, as discussed above with reference to block 320 in FIG. 3, the system may process the depth map (generated by the depth model) using a depth-to-segmentation model that is configured to translate depth maps into segmentation maps. As discussed above, in some aspects, the depth-to-segmentation model is configured to output classes corresponding to the consolidated groups of classes discussed above.

At block 420, the system computes a segmentation loss based on these two segmentation maps. For example, the system may compute a cross-entropy loss. As discussed above, the segmentation loss can then be used to refine the depth-to-segmentation model via backpropagation, as well as the depth model by backpropagation through the depth-to-segmentation model and then through the segmentation model.

Note that FIG. 4 is just one example of a method, and other methods including fewer, additional, or alternative steps are possible consistent with this disclosure.

Example Method for Training and Inferencing Using Depth Models

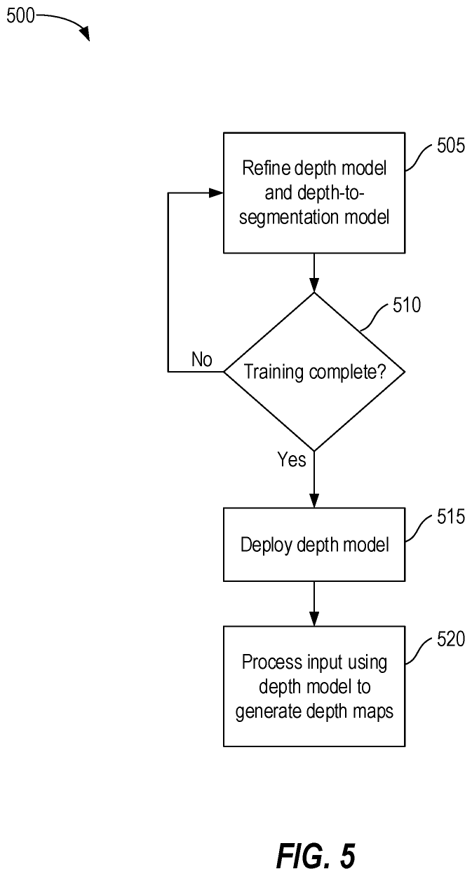

FIG. 5 depicts an example flow diagram illustrating a method 500 for training and inferencing using a depth model trained with the aid of a depth-to-segmentation model.

The method begins at block 505, where the system trains or refines a depth model (e.g., depth model 110 in FIG. 1A) and a depth-to-segmentation model (e.g., depth-to-segmentation model 125 in FIG. 1A). This may be accomplished, for example, using the method 300 discussed above with reference to FIG. 3, and/or the workflow 100A discussed above with reference to FIG. 1A. For example, the system may backpropagate a depth loss through the depth model. The system may also backpropagate a segmentation loss through the depth model, via the depth-to-segmentation model.

At block 510, the system determines whether training is complete or sufficient for deployment. This termination criteria may include a variety of elements, such as a minimum prediction accuracy of the depth model, a maximum time or amount of resources spent training the models, a number of epochs, whether any additional training samples remain, and the like. If the system determines that training is not complete, then the method 500 returns to block 505.

If, at block 510, the system determines that training is complete or sufficient, then the method 500 continues to block 515, where the depth model is deployed for use in inferencing. In some aspects, as discussed above, the depth-to-segmentation model is discarded or otherwise not used during inferencing. That is, during inferencing, input is not passed through the depth-to-segmentation model (or the pre-trained segmentation model, if one is used during training).

At block 520, the system can then process input (e.g., images) using the depth model in order to generate depth maps. As only the depth model is used during inferencing, the computational resources needed remain lower than conventional systems that use segmentation models. Further, as the depth model is trained using cross-task distillation, it provides improved accuracy over solely depth-based models.

Note that FIG. 5 is just one example of a method, and other methods including fewer, additional, or alternative steps are possible consistent with this disclosure.

Example Method for Training Machine Learning Models Based on Segmentation Loss

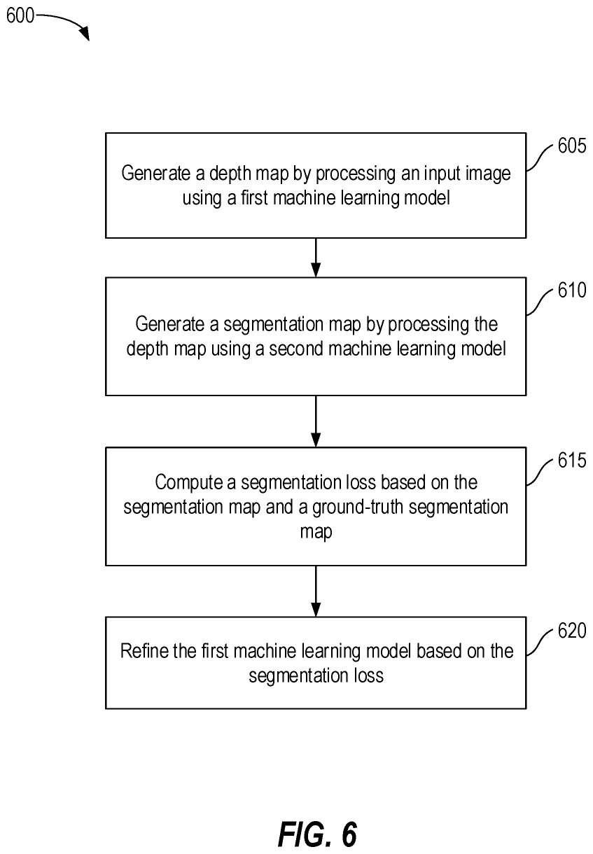

FIG. 6 depicts an example flow diagram illustrating a method 600 for training a machine learning model based on segmentation loss.

At block 605, a depth map is generated by processing an input image (e.g., input image 105 in FIG. 1A) using a first machine learning model (e.g., depth model 110 in FIG. 1A).

In some aspects, the input image is received from a monocular source.

At block 610, a segmentation map is generated by processing the depth map using a second machine learning model (e.g., depth-to-segmentation model 125 in FIG. 1A).

At block 615, a segmentation loss (e.g., segmentation loss 135 in FIG. 1A) is computed based on the segmentation map and a ground-truth segmentation map.

In some aspects, the ground-truth segmentation map is generated by processing the input image using a pre-trained segmentation machine learning model (e.g., pre-trained segmentation model 130 in FIG. 1A).

In some aspects, the ground-truth segmentation map comprises a set of classes, and computing the segmentation loss comprises consolidating the set of classes to a subset of classes, wherein the subset of classes contains fewer classes than the set of classes.

At block 620, the first machine learning model is refined based on the segmentation loss.

In some aspects, the method 600 further includes refining the second machine learning model based on the segmentation loss.

In some aspects, refining the second machine learning model based on the segmentation loss comprises generating a plurality of gradients by backpropagating the segmentation loss through the second machine learning model, and refining the first machine learning model based on the segmentation loss comprises backpropagating the plurality of gradients through the first machine learning model.

In some aspects, the method 600 further includes computing a depth loss based at least in part on the depth map, and refining the first machine learning model based on the depth loss.

In some aspects, the depth loss is computed based further on a ground-truth depth map.

In some aspects, the depth loss is a photometric loss computed by generating a synthesized version of the input image based on the depth map and at least a second input image and computing the photometric loss based on the synthesized version of the input image and the input image.

In some aspects, to generate output during inferencing, the first machine learning model is used to generate depth maps based on input images and the second machine learning model is not used during inferencing.

Note that FIG. 6 is just one example of a method, and other methods including fewer, additional, or alternative steps are possible consistent with this disclosure.

Example Method for Inferencing using a Machine Learning Model trained using

Segmentation Loss

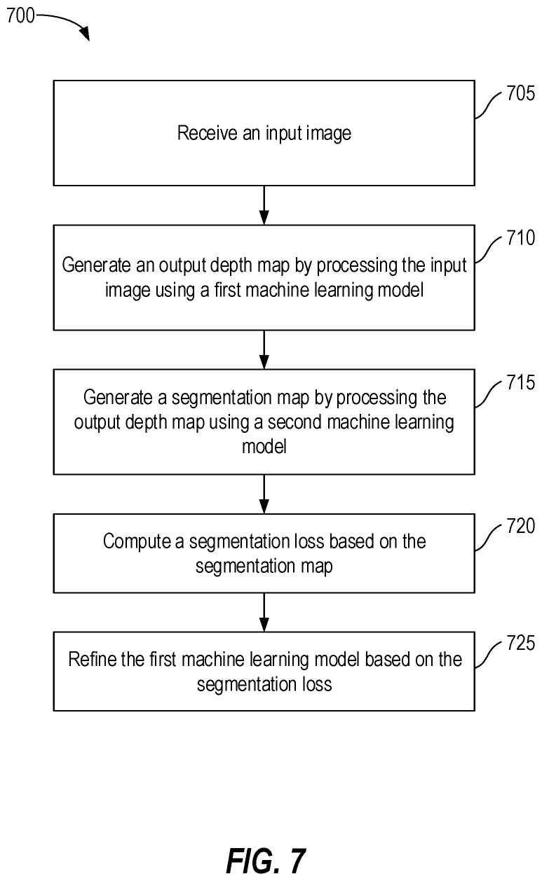

FIG. 7 depicts an example flow diagram illustrating a method 700 for inferencing using a machine learning model trained using segmentation loss.

At block 705, an input image is received.

At block 710, an output depth map is generated by processing the input image using a first machine learning model (e.g., depth model 110 in FIG. 1B).

At block 715, a segmentation map is generated by processing the output depth map using a second machine learning model.

At block 720, a segmentation loss (e.g., segmentation loss 135 in FIG. 1A) is computed based on the segmentation map.

At block 725, the first machine learning model is refined based on the segmentation loss.

In some aspects, the first machine learning model is used in a monocular system, and the input image is received from a monocular source.

Note that FIG. 7 is just one example of a method, and other methods including fewer, additional, or alternative steps are possible consistent with this disclosure.

Example Processing System for Depth Models Based on Segmentation Loss

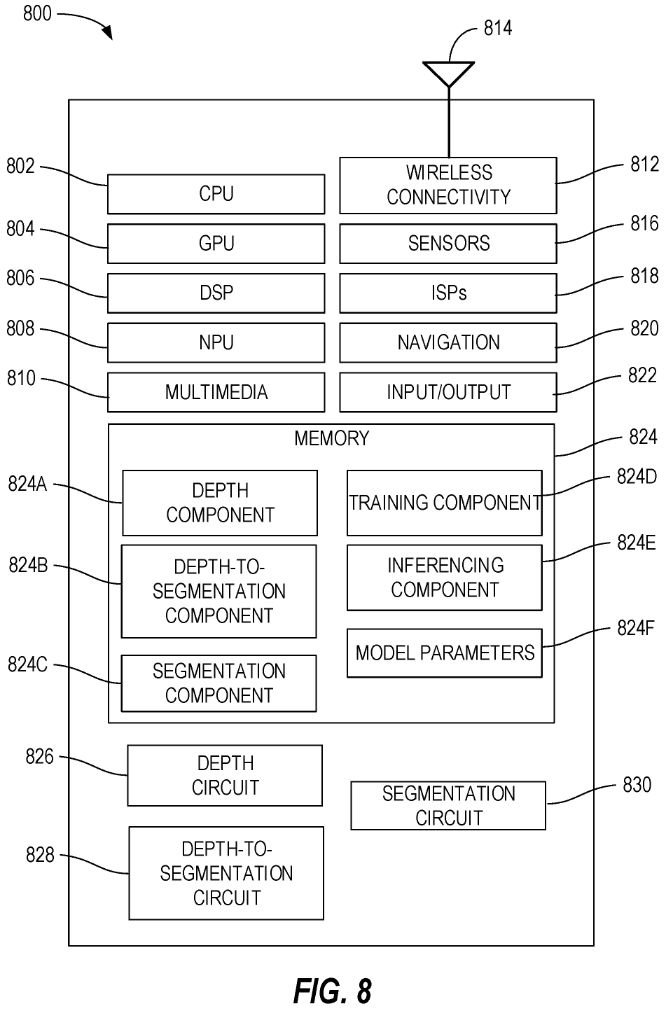

In some aspects, the workflows, techniques, and methods described with reference to FIGS. 1A-7 may be implemented on one or more devices or systems. FIG. 8 depicts an example processing system 800 configured to perform various aspects of the present disclosure, including, for example, the techniques and methods described with respect to FIGS. 1A-7.

Processing system 800 includes a central processing unit (CPU) 802, which in some examples may be a multi-core CPU. Instructions executed at the CPU 802 may be loaded, for example, from a program memory associated with the CPU 802 or may be loaded from a memory partition 824.

Processing system 800 also includes additional processing components tailored to specific functions, such as a graphics processing unit (GPU) 804, a digital signal processor (DSP) 806, a neural processing unit (NPU) 808, a multimedia processing unit 810, and a wireless connectivity component 812.

An NPU, such as 808, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 808 is a part of one or more of CPU 802, GPU 804, and/or DSP 806.

In some examples, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 812 is further connected to one or more antennas 814.

Processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an ARM or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes a depth component 824A, a depth-to-segmentation component 824B, a segmentation component 824C, a training component 824D, and an inferencing component 824E. The memory 824 also includes model parameters 824F. The depicted components, and others not depicted, may be configured to perform various aspects of the techniques described herein. Though depicted as discrete components for conceptual clarity in FIG. 8, depth component 824A, depth-to-segmentation component 824B, segmentation component 824C, training component 824D, and inferencing component 824E may be collectively or individually implemented in various aspects.

Processing system 800 further comprises depth circuit 826, depth-to-segmentation circuit 828, and segmentation circuit 830. The depicted circuits, and others not depicted, may be configured to perform various aspects of the techniques described herein.

For example, depth component 824A and depth circuit 826 may be used to generate depth maps based on input images. Depth-to-segmentation component 824B and depth-to-segmentation circuit 828 may be used to generate segmentation maps based on generated depth maps. Segmentation component 824C and segmentation circuit 830 may be used to generate segmentation maps based on input images. Training component 824D may be used to train the various models, while inferencing component 824E can be used to generate inferences using the trained depth model. The model parameters 824F can include trainable parameters (such as weights and, in some aspects, scale values for various losses).

Though depicted as separate components and circuits for clarity in FIG. 8, depth circuit 826, depth-to-segmentation circuit 828, and segmentation circuit 830 may collectively or individually be implemented in other processing devices of processing system 800, such as within CPU 802, GPU 804, DSP 806, NPU 808, and the like.

Generally, processing system 800 and/or components thereof may be configured to perform the methods described herein.

In some aspects, the processing system 800 can perform incremental on-device learning. For example, inferencing component 824E may generate a depth map (e.g., using the depth component 824A) for a received input image during runtime. This depth map may then be used (alone, or as part of a batch of maps generated during inferencing) to refine the depth model (e.g., by generating segmentation map(s) based on the depth map(s), computing segmentation loss(es) based on the segmentation map(s), and refining the depth model based on the segmentation loss(es), as discussed above).

Notably, in other aspects, aspects of processing system 800 may be omitted, such as where processing system 800 is a server computer or the like. For example, multimedia component 810, wireless connectivity component 812, sensors 816, ISPs 818, and/or navigation component 820 may be omitted in other aspects. Further, aspects of processing system 800 maybe distributed between multiple devices.

### Example Clauses

Clause 1: A method, comprising: generating a depth map by processing an input image using a first machine learning model; generating a segmentation map by processing the depth map using a second machine learning model; computing a segmentation loss based on the segmentation map and a ground-truth segmentation map; and refining the first machine learning model based on the segmentation loss.

Clause 2: The method according to Clause 1, further comprising refining the second machine learning model based on the segmentation loss.

Clause 3: The method according to any one of Clauses 1-2, wherein: refining the second machine learning model based on the segmentation loss comprises generating a plurality of gradients by backpropagating the segmentation loss through the second machine learning model, and refining the first machine learning model based on the segmentation loss comprises backpropagating the plurality of gradients through the first machine learning model.

Clause 4: The method according to any one of Clauses 1-3, further comprising: computing a depth loss based at least in part on the depth map; and refining the first machine learning model based on the depth loss.

Clause 5: The method according to any one of Clauses 1-4, wherein the depth loss is computed based further on a ground-truth depth map.

Clause 6: The method according to any one of Clauses 1-5, wherein the depth loss is a photometric loss computed by: generating a synthesized version of the input image based on the depth map and at least a second input image; and computing the photometric loss based on the synthesized version of the input image and the input image.

Clause 7: The method according to any one of Clauses 1-6, wherein the ground-truth segmentation map is generated by processing the input image using a pre-trained segmentation machine learning model.

Clause 8: The method according to any one of Clauses 1-7, wherein: the ground-truth segmentation map comprises a set of classes, and computing the segmentation loss comprises consolidating the set of classes to a subset of classes, wherein the subset of classes contains fewer classes than the set of classes.

Clause 9: The method according to any one of Clauses 1-8, wherein, to generate output during inferencing: the first machine learning model is used to generate depth maps based on input images, and the second machine learning model is not used during inferencing.

Clause 10: The method according to any one of Clauses 1-9, wherein the input image is received from a monocular source.

Clause 11: A method, comprising: receiving an input image; generating an output depth map by processing the input image using a first machine learning model, generating a segmentation map by processing the depth map using a second machine learning model, computing a segmentation loss based on the segmentation map, and refining the first machine learning model based on the segmentation loss.

Clause 12: The method according to Clause 11, wherein the first machine learning model is used in a monocular system, and the input image is received from a monocular source.

Clause 13: A system, comprising: a memory comprising computer-executable instructions; and one or more processors configured to execute the computer-executable instructions and cause the processing system to perform a method in accordance with any one of Clauses 1-12.

Clause 14: A system, comprising means for performing a method in accordance with any one of Clauses 1-12.

Clause 15: A non-transitory computer-readable medium comprising computer-executable instructions that, when executed by one or more processors of a processing system, cause the processing system to perform a method in accordance with any one of Clauses 1-12.

Clause 16: A computer program product embodied on a computer-readable storage medium comprising code for performing a method in accordance with any one of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of a list of items refers to any combination of those items, including single members. As an example,” at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
generating a depth map by processing an input image using a first machine learning model;
generating a segmentation map by processing the depth map using a second machine learning model;
computing a segmentation loss based on the segmentation map and a ground-truth segmentation map; and
refining the first machine learning model based on the segmentation loss.

2. The processor-implemented method of claim 1, further comprising refining the second machine learning model based on the segmentation loss.

3. The processor-implemented method of claim 1, wherein:
refining the second machine learning model based on the segmentation loss comprises generating a plurality of gradients by backpropagating the segmentation loss through the second machine learning model; and
refining the first machine learning model based on the segmentation loss comprises backpropagating the plurality of gradients through the first machine learning model.

4. The processor-implemented method of claim 1, further comprising:
computing a depth loss based at least in part on the depth map; and
refining the first machine learning model based on the depth loss.

5. The processor-implemented method of claim 4, wherein the depth loss is computed based further on a ground-truth depth map.

6. The processor-implemented method of claim 4, wherein the depth loss is a photometric loss computed by:
generating a synthesized version of the input image based on the depth map and at least a second input image; and
computing the photometric loss based on the synthesized version of the input image and the input image.

7. The processor-implemented method of claim 1, wherein the ground-truth segmentation map is generated by processing the input image using a pre-trained segmentation machine learning model.

8. The processor-implemented method of claim 1, wherein:
the ground-truth segmentation map comprises a set of classes, and
computing the segmentation loss comprises consolidating the set of classes to a subset of classes, wherein the subset of classes contains fewer classes than the set of classes.

9. The processor-implemented method of claim 1, wherein, to generate output during inferencing:
the first machine learning model is used to generate depth maps based on input images, and
the second machine learning model is not used during inferencing.

10. The processor-implemented method of claim 1, wherein the input image is received from a monocular source.

11. A processing system, comprising:
a memory comprising computer-executable instructions; and
one or more processors configured to execute the computer-executable instructions and cause the processing system to perform an operation comprising:
generating a depth map by processing an input image using a first machine learning model;
generating a segmentation map by processing the depth map using a second machine learning model;
computing a segmentation loss based on the segmentation map and a ground-truth segmentation map; and
refining the first machine learning model based on the segmentation loss.

12. The processing system of claim 11, the operation further comprising refining the second machine learning model based on the segmentation loss.

13. The processing system of claim 11, wherein:
refining the second machine learning model based on the segmentation loss comprises generating a plurality of gradients by backpropagating the segmentation loss through the second machine learning model; and
refining the first machine learning model based on the segmentation loss comprises backpropagating the plurality of gradients through the first machine learning model.

14. The processing system of claim 11, the operation further comprising:
computing a depth loss based at least in part on the depth map; and
refining the first machine learning model based on the depth loss.

15. The processing system of claim 14, wherein the depth loss is computed based further on a ground-truth depth map.

16. The processing system of claim 14, wherein the depth loss is a photometric loss computed by:
generating a synthesized version of the input image based on the depth map and at least a second input image; and
computing the photometric loss based on the synthesized version of the input image and the input image.

17. The processing system of claim 11, wherein the ground-truth segmentation map is generated by processing the input image using a pre-trained segmentation machine learning model.

18. The processing system of claim 11, wherein:
the ground-truth segmentation map comprises a set of classes, and
computing the segmentation loss comprises consolidating the set of classes to a subset of classes, wherein the subset of classes contains fewer classes than the set of classes.

19. The processing system of claim 11, wherein, to generate output during inferencing:
the first machine learning model is used to generate depth maps based on input images, and
the second machine learning model is not used during inferencing.

20. The processing system of claim 11, wherein the input image is received from a monocular source.

21. A non-transitory computer-readable medium comprising computer-executable instructions that, when executed by one or more processors of a processing system, cause the processing system to perform an operation comprising:
generating a depth map by processing an input image using a first machine learning model;
generating a segmentation map by processing the depth map using a second machine learning model;
computing a segmentation loss based on the segmentation map and a ground-truth segmentation map; and
refining the first machine learning model based on the segmentation loss.

22. The non-transitory computer-readable medium of claim 21, wherein:
refining the second machine learning model based on the segmentation loss comprises generating a plurality of gradients by backpropagating the segmentation loss through the second machine learning model; and
refining the first machine learning model based on the segmentation loss comprises backpropagating the plurality of gradients through the first machine learning model.

23. The non-transitory computer-readable medium of claim 21, the operation further comprising:
computing a depth loss based at least in part on the depth map; and
refining the first machine learning model based on the depth loss.

24. The non-transitory computer-readable medium of claim 23, wherein the depth loss is a photometric loss computed by:
generating a synthesized version of the input image based on the depth map and at least a second input image; and
computing the photometric loss based on the synthesized version of the input image and the input image.

25. The non-transitory computer-readable medium of claim 21, wherein:
the ground-truth segmentation map comprises a set of classes, and
computing the segmentation loss comprises consolidating the set of classes to a subset of classes, wherein the subset of classes contains fewer classes than the set of classes.

26. A method, comprising:
receiving an input image;
generating an output depth map by processing the input image using a first machine learning model; and
refining the first machine learning model, comprising:
generating a segmentation map by processing the output depth map using a second machine learning model,
computing a segmentation loss based on the segmentation map, and
refining the first machine learning model based on the segmentation loss.

27. The method of claim 26, wherein:
the first machine learning model is used in a monocular system, and
the input image is received from a monocular source.

28. The method of claim 26, further comprising:
computing a depth loss based at least in part on the output depth map; and
refining the first machine learning model based further on the depth loss.

29. The method of claim 28, wherein the depth loss is a photometric loss computed by:
generating a synthesized version of the input image based on the output depth map and at least a second input image; and
computing the photometric loss based on the synthesized version of the input image and the input image.

30. The method of claim 29, wherein:
the segmentation loss is computed based further on a ground-truth segmentation map,
the ground-truth segmentation map comprises a set of classes, and
computing the segmentation loss comprises consolidating the set of classes to a subset of classes, wherein the subset of classes contains fewer classes than the set of classes.
